(19) United States
(12) Patent Application Publication
(10) Pub. No.: US 2008/0223306 A1
(43) Pub. Date: Sep. 18, 2008

(54) Tabby's massaging catrod

(76) Inventor: Julian Franciscus Vaughn, Altoona, PA (US)

Correspondence Address: Julian Franciscus Vaughn, # 714, 1010 12th st., Altoona, PA, 16601, US

(21) Appl. No.: 11/818,960

(22) Filed: Mar. 5, 2007

(51) Int. Cl. A01K 29/00

(52) U.S. Cl. 119/707

(57) ABSTRACT

The “Tabby's Massaging Catrod” is a cat toy that uses a Massaging Pin attachment to offer a cat a surface to massage itself on. The Master holds the rod, and with it can cast a toy ball for the cat to chase. This ball is attached to a spool, and string that is housed inside the rod. This making it different, and newly distinguishable from other cat toys that look like a simple fishing rod.

I, Julian Franciscus Vaughn, have invented a new article of manufacture, as set forth in the following specification. I have entitled this invention Tabbys Massaging Catrod. This claimed device is used to entertain cast, as well as offer them a surface to massage themselves on. The manner and process of making this device is simple. Basic carpentry, and woodwork is to be incorporated in forming the basic shapes of the Rod Body, and Massage Pin. The Plastic Cup and Spool are to be formed by basic dye mold injection. The metal components would be a product of basic metal forming. And, the String is just a basic fabric form.

The cylinder we see underneath the device, serves as a studded, grooved, rolling pin which the cat walks back and forth under, arching its back, massaging itself, as the human holds this rod. The human entertains the cat by casting a ball attached to a shaped weight, which is attached to a string which is would around a spool, which itself is housed within the rod and centered on a pin. The cat bites and chases this ball. There is also a cylinder on the top, front of the rod where a laser pointer could be housed.

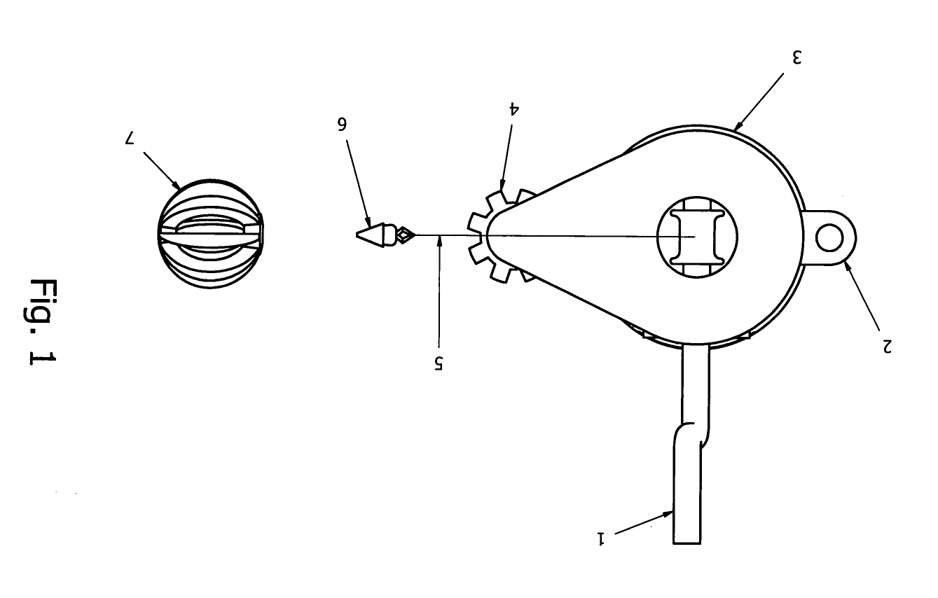

FIG. 1. is a front view of a cat toy showing my new article of manufacture:

1. is the Spool Crank;

2. is the top, front Cylinder;

3. is the Rod Body & Main Handle;

4. is the rolling Massage Pin;

5. is the String which is wound around the Spool within the Rod Body;

6. is the Weight, which snaps into the Ball;

7. is the Ball.

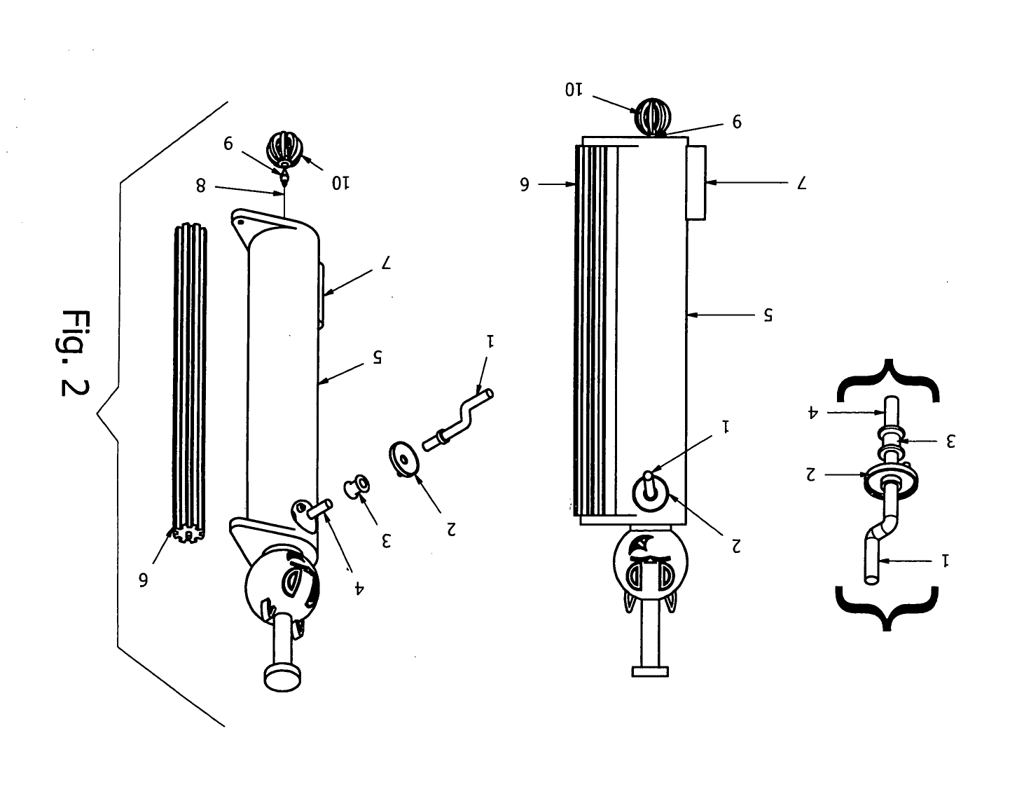

FIG. 2 is a Cross-sectional/Exploded view thereof;

1. is the Spool Crank which is fused to the Spool, which passes through the Plastic Cap;

2. is the Plastic Cap which fits snugly into the hold drilled into the Rod Body;

3. is the Spool;

4. Is the Spool Centering Pin, as housed within the Rod Body;

5. is the wooden Rod Body;

6. is the rolling Massage Pin;

7. is the top front Cylinder;

8. is the String;

9. is the Weight; and

10. is the Ball.

I claim: the utility for an article of manufacture as shown, and described

What I claim my invention is:

1. The massaging pin, as affixed to my cat-rod cat toy: design, as a new machine that performs the specific function of being a studded surface that a cat can massage itself on. This surface rolls, as affixed to my Cat Toy design as shown, and described.
